(19) United States
(12) Patent Application Publication
(10) Pub. No.: US 2005/0086039 A1
(43) Pub. Date: Apr. 21, 2005

(54) Method and system for comparing different integrated circuit technologies

(76) Inventor: Christopher L. Hamlin, Los Gatos, CA (US)

Correspondence Address: LSI LOGIC CORPORATION, 1621 BARBER LANE, MS: D-106, MILPITAS, CA, 95035, US

(21) Appl. No.: 10/689,494

(22) Filed: Oct. 20, 2003

(51) Int. Cl. G06F 9/45

(52) U.S. Cl. 703/22

(57) ABSTRACT

The present invention is directed to a method and system for comparing different IC technologies. According to an exemplary aspect of the present invention, an interactive computer program takes a multidimensional space represented by all of the variability associated with design and production of complex semiconductor devices, and collapses it down into a smaller space representing key variables of interest, and particularly the key variables of interest to a customer such as risk and cost. Sliders may be used by a customer to set input variables reflecting realistic requirements on the part of the customer. For output, 3-D and/or 2-D graphics may be used to show how the IC technologies visually line up in relation to one another in terms of risk and also in terms of cost.

### FIELD OF THE INVENTION

This invention relates generally to integrated circuits, and particularly to a method and system for comparing different integrated circuit technologies such as RapidChip™, ASICs, FPGAs, ASSPs and the like.

### BACKGROUND OF THE INVENTION

A customer often finds it difficult to decide which integrated circuit technology optimally suits the needs of the customer when building an integrated circuit (IC) product. There are many technologies available on the market: the ASIC (application-specific integrated circuit), the FPGA (field-programmable gate array), the ASSP (application-specific standard product), the RapidChip™ (developed by LSI Logic Corp.), and the like. Each technology has its advantages and shortcomings and typically involves many variables. The customer may also have many requirements for the product. Thus, positioned in such a multidimensional space, the customer often feels confused. Thus, it would be desirable to provide a method and system for comparing different IC technologies such as RapidChip™, ASICs, FPGAs, ASSPs, and the like with regards to advantages and shortcomings of each technology.

### SUMMARY OF THE INVENTION

Accordingly, the present invention is directed to a method and system for comparing different IC technologies. According to an exemplary aspect of the present invention, an interactive computer program takes a multidimensional space represented by all of the variability associated with design and production of complex semiconductor devices, and collapses it down into a smaller space representing key variables of interest, and particularly the key variables of interest to a customer. Risk and cost are two of the key variables of interest to a customer. Thus, risk and cost may be the output variables in the computer program of the present invention. Sliders may be used by a customer to set input variables reflecting realistic requirements on the part of the customer. The sliders may be grabbed with a cursor and a mouse and moved back and forth on a slider scale so that numerical values of interest may be set by a user of the program. There may be a small number of input variables such as the number of customizable gates, the number of IP (intellectual property) blocks, the maximum time to prototype (time to market), the yearly product volume, and the like, whose values may be set with these sliders. For output, 3-D and/or 2-D graphics may be used to show how the IC technologies visually line up in relation to one another in terms of risk and also in terms of cost. Other than these simple input variables and this fairly simple output space (represented by 3-D graphics and/or 2-D graphics), everything else (e.g., calculations, algorithms, and the like) may be reflected in an underlying model that is run in the background.

It is to be understood that both the foregoing general description and the following detailed description are exemplary and explanatory only and are not restrictive of the invention as claimed. The accompanying drawings, which are incorporated in and constitute a part of the specification, illustrate an embodiment of the invention and together with the general description, serve to explain the principles of the invention.

### BRIEF DESCRIPTION OF THE DRAWINGS

The numerous advantages of the present invention may be better understood by those skilled in the art by reference to the accompanying figures in which:

FIG. 1 is a schematic block diagram illustrating an exemplary computer system in which the present invention may be implemented;

FIGS. 2 through 4 are exemplary task windows of a graphical user interface wherein exemplary risk plots are shown in accordance with the present invention;

FIG. 5 is an exemplary task window of a graphical user interface wherein exemplary success plots are shown in accordance with the present invention;

FIG. 6 shows an additional exemplary cutaway view of a success plot in accordance with the present invention;

FIGS. 7 through 9 are exemplary task windows of a graphical user interface wherein exemplary global cost plots are shown in accordance with the present invention;

FIG. 10 is a schematic block diagram illustrating an exemplary system for the platform comparator in accordance with the present invention;

FIGS. 11 and 12 show exemplary processes of platform comparator Java® initiation and constructor in accordance with the present invention;

FIG. 13 shows an exemplary action performed event loop in accordance with the present invention;

FIG. 14 shows an exemplary exit event loop in accordance with the present invention;

FIG. 15 shows an exemplary log/linear event loop in accordance with the present invention;

FIGS. 16 and 17 show an exemplary linear labelslider constructor and event routine in accordance with the present invention;

FIGS. 18 and 19 show an exemplary logarithmic labelslider constructor and event routine in accordance with the present invention; and

FIGS. 20 through 22 show exemplary labelslider methods in accordance with the present invention.

### DETAILED DESCRIPTION OF THE INVENTION

Reference will now be made in detail to the presently preferred embodiments of the invention, examples of which are illustrated in the accompanying drawings.

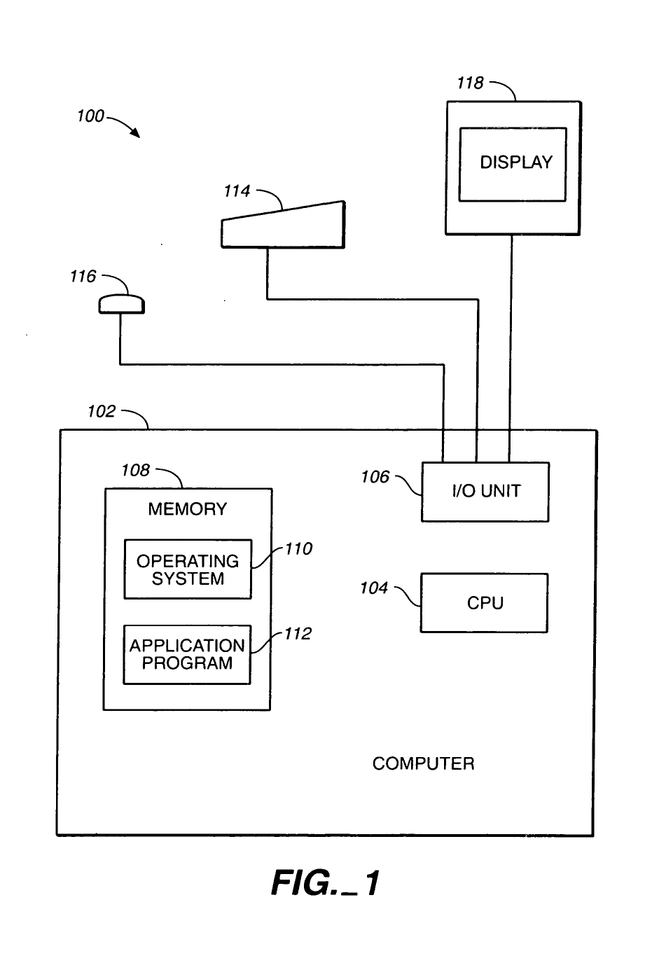

FIG. 1 is a schematic block diagram illustrating an exemplary computer system 100 in which the present invention may be implemented. The computer system 100 includes a computer 102 having a central processing unit (CPU) 104, an input/output unit 106, and a memory 108 containing various programs used by the computer 102 such as an operating system 110 and one or more application programs 112. An end-user of the computer system 100 communicates with the computer 102 by means of various input devices (e.g., keyboard 114, mouse 116, and the like) which transfer information to the computer 102 via the input/output unit 106. The computer 102 replies to this input data, among other ways, by providing responsive output to the end-user, for example, by displaying appropriate text and images on the screen of a display monitor 118.

The operating system 110 may include a graphical user interface (GUI) by which the operating system and any applications it may be running (e.g., a word-processing program) may communicate with a user of the computer system. A commonly used GUI implementation employs a desktop metaphor in which the screen of the monitor is regarded as a virtual desktop. The desktop is an essentially two-dimensional working template area supporting various graphical objects, including one or more display regions. Information generated by application programs 112 or the operating system 110 may be displayed on the desktop within display regions (e.g., task windows, dialog boxes, pop-up menus, pull-down menus, drop-down lists, icons, and the like). Through a graphical user interface,a user may interact with the operating system, and any applications it may be running, by manipulating a cursor appropriately within the display regions and by entering information with the keyboard or other input devices.

One purpose of the present invention is to develop a computer program (“platform comparator”) to allow a user or customer to compare RapidChip™ technology with other technologies such as ASIC (application-specific integrated circuit), and FPGA (field-programmable gate array), and the like. The program is preferably an interactive program that may be easily used not only by experts but also by people who are not experts such as customers, reporters, financial analysts, vendors and so on. The process of comparing these IC technologies is often quite complex. In a preferred embodiment, the present invention takes a multidimensional space represented by all of the variability associated with design and production of complex semiconductor devices, and collapses it down into a smaller space representing key variables of interest, and particularly the key variables of interest to a customer, because the customer often does not care about all of the underlying variability and the underlying issues as long as the customer's needs are met. Risk and cost are two of the key variables of interest to a customer. Thus, risk and cost may be the output variables in the computer program of the present invention. Accordingly, one purpose of the present invention is to find a straightforward way of representing this multidimensional space and all of the variability captured in these technologies and collapsing it to a very simple expression of risk and cost that also takes account of the customer's objectives. The present invention may help a customer to relatively easily arrive at objective assessments of the relative risks and costs of the different technologies under assumptions of time.

Visual means may be used to help achieve the foregoing purposes. In a preferred embodiment, sliders may be used by a customer to set input variables reflecting realistic requirements on the part of the customer. The sliders may be grabbed with a cursor and a mouse and moved back and forth on a slider scale so that numerical values of interest may be set by a user of the program. There may be a small number of input variables such as the number of customizable gates, the number of IP (intellectual property) blocks, the maximum time to prototype (time to market), the yearly product volume, and the like, whose values may be set with these sliders. For output, 3-D and/or 2-D graphics may be used to show how the IC technologies visually line up in relation to one another in terms of risk and also in terms of cost.

Other than these simple input variables and this fairly simple output space (represented by 3-D graphics and/or 2-D graphics), everything else may be reflected in an underlying model that is run in the background. Thus, a user actually using the program need not be aware of all of the subtlety, the complexity, the assumptions and the data driving the model, and the model operated on. However, the model may be realistic and appropriate. The model may preferably accurately reflect the realities of these IC technologies and convert the input variables to the output presentation in the form of risk and cost. The computation performed by the model may be real-time computation so that a user can obtain the output result quickly. In a preferred embodiment, the bulk of the model includes assumptions, algorithms and data pertaining to the relevant technologies, and the model preferably operates in the background silently and out of sight. The model is preferably a statistical model that is based on the error function and assumptions about labor (which is critical, labor is a function of cost) and various other cost factors, such as die size, silicon area, the size and declining efficiency of growing engineering teams, the economic consequences of shrinking market windows, and the like.

Thus, in a preferred embodiment, the present invention takes fairly simple but realistic input that reflects the customer's objectives, and provides visually accessible and interpretable 3-D output that shows how the IC technologies stack up against one another. The output is driven by the model as a function of the input. The program of the present invention is preferably a data-driven, interactive, graphical, and modeling program that allows a user to interact with various variables.

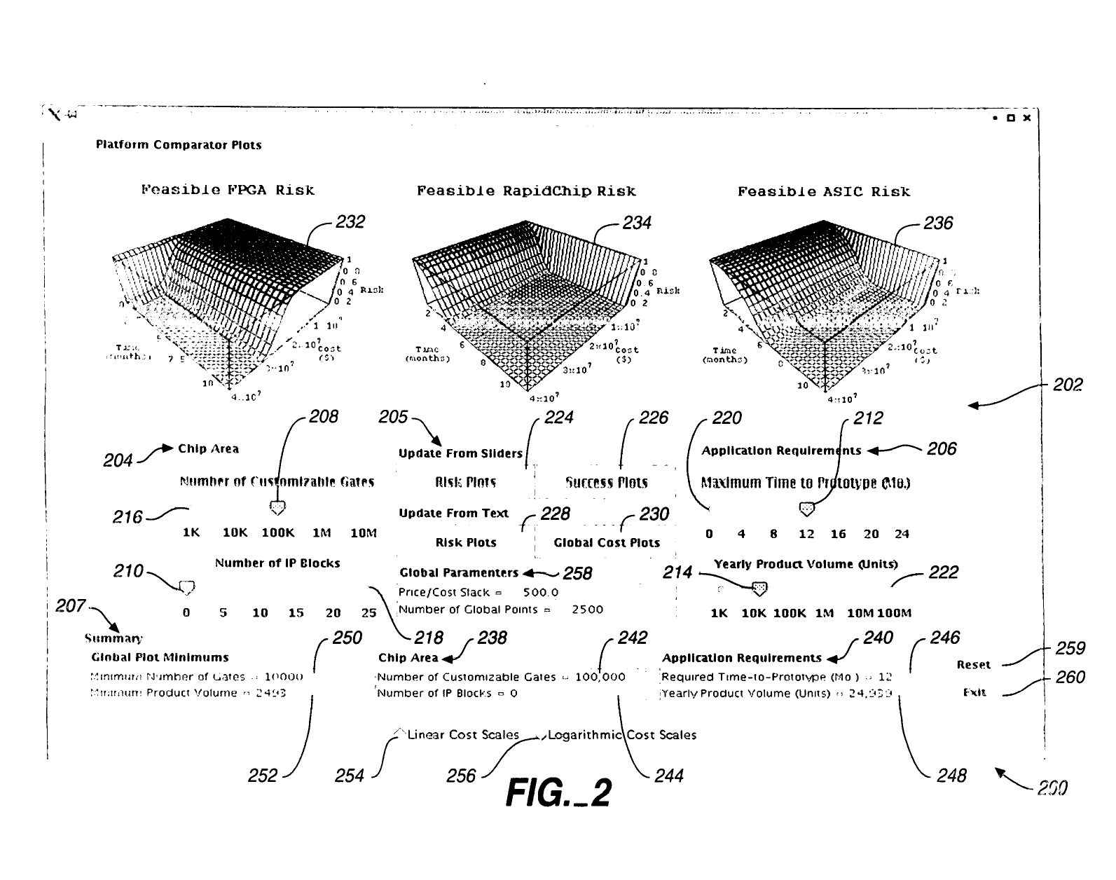

FIGS. 2 through 4 are exemplary task windows of a graphical user interface wherein exemplary risk plots are shown in accordance with the present invention. It is understood that the task windows illustrated in FIGS. 2 through 9 may be shown on the screen of the display monitor 118 shown in FIG. 1.

As shown in FIG. 2, a task window 200 includes a presentation area 202 at the top, a chip area region 204, a plot selection region 205 and an application requirements region 206 in the middle, and a summary region 207 near the bottom. In the chip area region 204 and the application requirements region 206, a user may choose common input variables for RapidChip™, ASIC, and FPGA technologies (or platforms). For example, in the chip area region 204, a user my set the desired number of customizable gates and the desired number of IP (intellectual property) blocks by moving sliders 208 and 210 along slide scales 216 and 218, respectively. In the application requirements region 206, a user may set the desired maximum time to prototype (the desired maximum time to market) in months and the desired yearly product volume in units by moving sliders 212 and 214 along slide scales 220 and 222, respectively. The scales 218 and 220 are preferably a linear scale. The scales 216 and 222 are preferably a special logarithmic scale, where the decades are logged (because there is a range to show) but the scale between the decades is actually linear (because it's easier to set a slider linearly). Those of ordinary skill in the art will understand that a user may set an input variable value by manipulating a computer mouse to grab and move a corresponding slider to a desired location. For example, the common input variables shown in FIG. 2 have the following values: the number of customizable gates is 100,000; the number of IP blocks is 0; the maximum time to prototype is 12 months; and the yearly product volume is 24,939.

The summary region 207 includes a chip area section 238 and an application requirements section 240. The chip area section 238 includes a subsection 242 displaying the value of the number of customized gates, and a subsection 244 displaying the number of IP blocks. The application requirements section 240 includes a subsection 246 displaying the required time-to-prototype in months, and a subsection 248 displaying the yearly product volume in units. As shown, the input values shown in the subsections 242, 244, 246, and 248 are the same as the input values indicated by the sliders 208, 210, 212, and 214, respectively. According to one aspect of the present invention, a user may set an input variable value by entering a number in the corresponding subsection 242, 244, 246, or 248 directly using a keyboard, a pull-down menu, or the like, instead of using one of the sliders 208, 210, 212, and 214. In a preferred embodiment, whenever an input variable value shown in the subsection 242, 244, 246, or 248 changes, the corresponding slider 208, 210, 212, or 214 may automatically move to a new location representing the new input variable value. Alternatively, whenever the slider 208, 210, 212, or 214 moves (thus a corresponding input variable value changes), the new input variable value may be automatically shown in the corresponding subsection 242, 244, 246, 248.

The summary region 207 further includes a global plot minimums section having a subsection 250 displaying the minimum number of gates and a subsection 252 displaying a minimum product volume. In a preferred embodiment, the minimum number of gates displayed in the subsection 250 is one tenth (1/10) of the number of customizable gates displayed in the subsection 242 and represented by the location of the slider 208 on the scale 216. The minimum product volume displayed in the subsection 252 is preferably one tenth (1/10) of the yearly product volume displayed in the subsection 248 and represented by the location of the slider 214 on the scale 222. The minimum number of gates displayed in the subsection 250 and the minimum product volume displayed in the subsection 252 are used when a global plot are made (e.g., by pressing a global cost plots updated from text button 230). The global plots will be described in detail below.

The summary region 207 further includes a reset button 259 and an exit button 260. When the rest button 259 is pressed, all input variables may be reset to predetermined initial values. When the exit button 260 is pressed, the computer program of the present invention may exit the task window 200.

The plot selection region 205 may enable a user to select a plot type to be shown in the presentation area 202. The plot selection region 205 includes a risk plots updated from sliders button 224, a success plots updated from sliders button 226, a risk plots updated from text button 228, a global cost plots updated from text button 230, and a global parameters section 258. After a user selects the desired input variable values by either moving the sliders 208, 210, 212, 214 or entering the values directly in the subsections 242, 244, 246, 248, the user may push the button 224, 226, 228 or 230 to choose which plot type to be shown in the presentation area 202. After one of the buttons 224, 226, 228 and 230 is pushed, the program of the present invention is run in the background, and the output result is displayed with the plot type selected by the user.

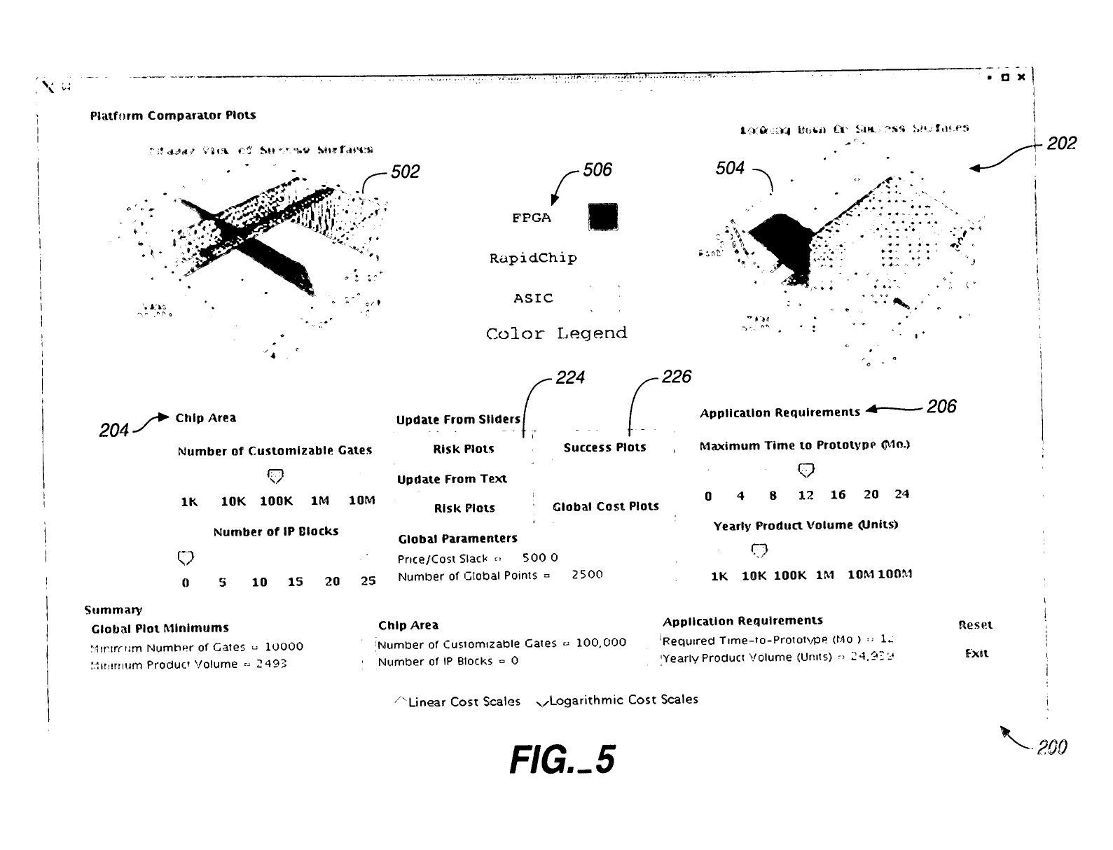

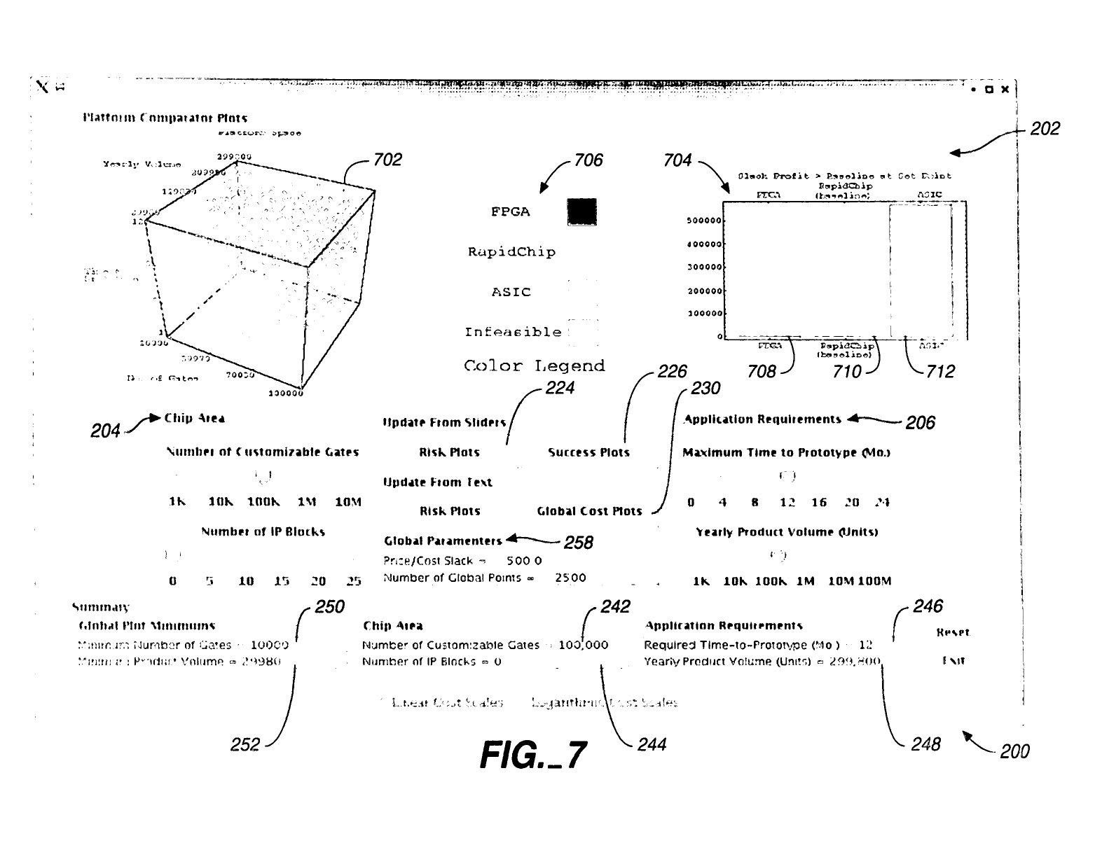

FIG. 2 shows that the button 224 is pushed (there is a square around the letters “Risk Plots”). As a result, the program of the present invention computes risk surfaces for these three technologies. As shown, the presentation area 202 includes a feasible FPGA risk plot 232, a feasible RapidChip risk plot 234, and a feasible ASIC risk plot 236. Each of the risk plots 232, 234 and 236 is a 3-D plot having a time axis, a cost axis, and a risk axis. Thus, each risk surface has two independent variables: the overall project cost and the overall project time (the time to market). The scale range of the time axis is preferably set by the maximum time to prototype indicated by the slider 212. For example, as shown in FIG. 2, the maximum time to prototype indicated by the slider 212 is 12 months, and the time axis for all three risk plots 232, 234, and 236 therefore has 12 months as the maximum value. The scale range of the cost axis is computed and set by the program because cost is a function of the number of customizable gates, the time to market, and the product volume. It is noted that by pushing a linear cost scales button 254 or a logarithmic cost scales button 256 located at the bottom of the task window 200, whether the scale of the cost axis in the risk plots and the success plots (see, e.g., the success plots 502 and 504 in FIG. 5) is linear or logarithmic may be chosen. For example, FIG. 2 shows that the linear cost scales button 254 is pushed, thus the scale of the cost axis of the risk plots 232, 234, and 236 is a linear scale. One purpose for having the logarithmic cost scale option is that in some cases it is easier to see the distribution of a variable of interest for comparative purposes when using the logarithmic scale. In an alternative embodiment, the axis scale ranges of the risk plot, the success plot, and the scatter plot (see., e.g., the scatter plot 702 in FIG. 7) may also be adjusted directly by a user using the cursor to directly manipulate the values on the axes.

In a preferred embodiment, different risks of the risk surface may be colored differently. For example, red may be used to represent danger (guaranteed to fail), and green may be used to mean safe (guaranteed to be successful). This way, different risks involved when using FPGA, RapidChip™ and ASIC technologies with a common set of input variable values may be compared by observing these three plots 232, 234, and 236. For example, as shown in FIG. 2, RapidChip™ is the least risky when a user plans to make 24,939 units, each unit with 100,000 customizable gates, with a maximum time to prototype of 12 months.

It is noted that the risk surfaces of the plots 232, 234, and 236 have slopes because the present program is established based on a statistical model. Indeed, with a large chip project, there is some uncertainty at the onset of the project as to exactly how much the project is going to cost and exactly how risky the project is. This is a natural part of the process. Ideally, one would make that uncertainty zero. However, in real life, it is impossible. Thus, the present program models this uncertainty with a distribution function whose parameters are set to conform to what the real data will look like. Moreover, the present program also allows a user to set these parameters fairly accurately. That is why these risk surfaces (especially in the case of ASIC) are sloped because there is an uncertainty in cost. Because there is less uncertainty in FPGA and RapidChip™, the risk surfaces for FPGA and RapidChip™ have the steeper slope than that of ASIC.

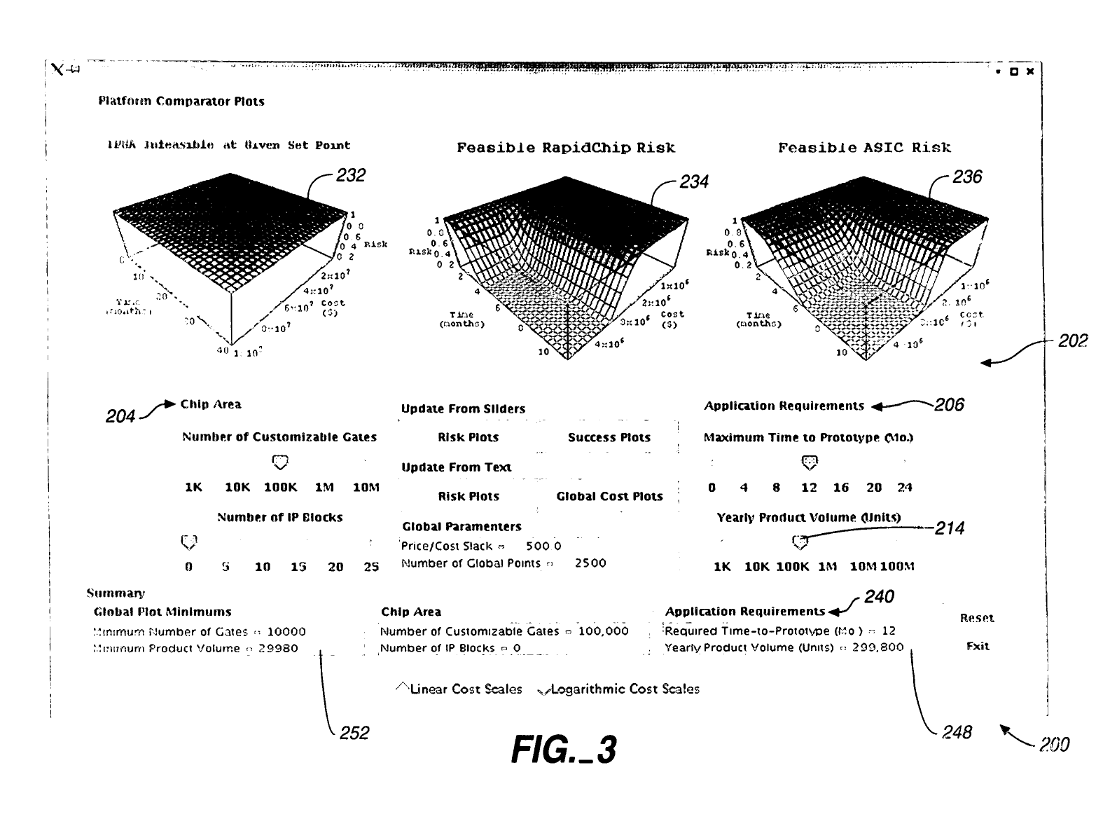

When the yearly product volume is changed to 299,800 units (see the subsection 248 and the location of the slider 214 shown in FIG. 3) from 24,939 units shown in FIG. 2, the task window 200 shown in FIG. 2 changes to the task window 200 shown in FIG. 3. As shown in FIG. 3, the three risk plots 232, 234, and 236 may change accordingly, and the subsection 252 shows a new value of 29,980 (1/10 of 299,800). It is noted that the risk surface for FPGA 232 now has a value of 1, i.e., 100% risk. That is, it is entirely infeasible to use FPGA technology to produce 299,800 units, each unit with 100,000 customizable gates, with a maximum time of prototype of 12 months.

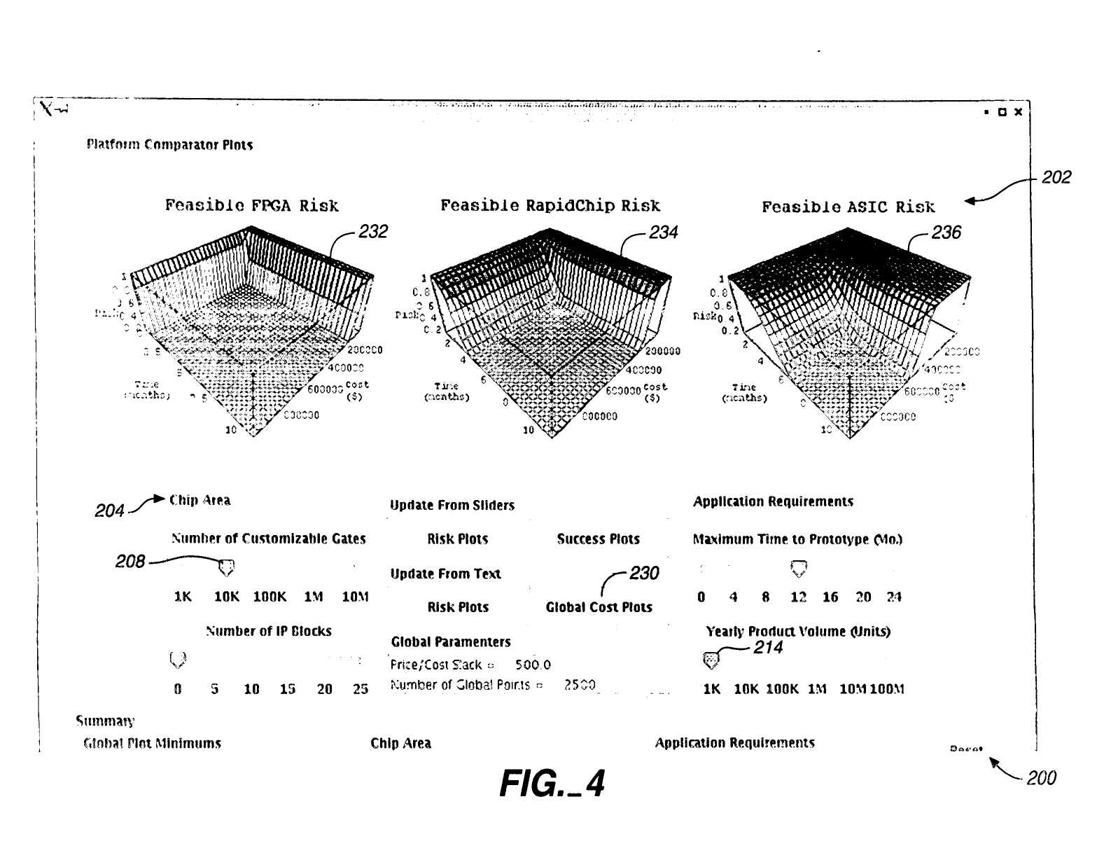

When the yearly product volume is changed to 1,000 units (see the location of the slider 214 shown in FIG. 4) from 24,939 units shown in FIG. 2, and the number of customizable gates is changed to 10,000 (see the location of the slider 208 shown in FIG. 4) from 100,000 shown in FIG. 2, the task window 200 shown in FIG. 2 changes to the task window 200 shown in FIG. 4 (only part of the task window 200 is shown). As shown in FIG. 4, the three risk plots 232, 234, and 236 may change accordingly, and the FPGA technology is the least risky with the foregoing described input variable values. This is easily understandable because only 10,000 customizable gates are involved, which, for RapidChip™ and ASIC, is an almost absurdly small number of gates.

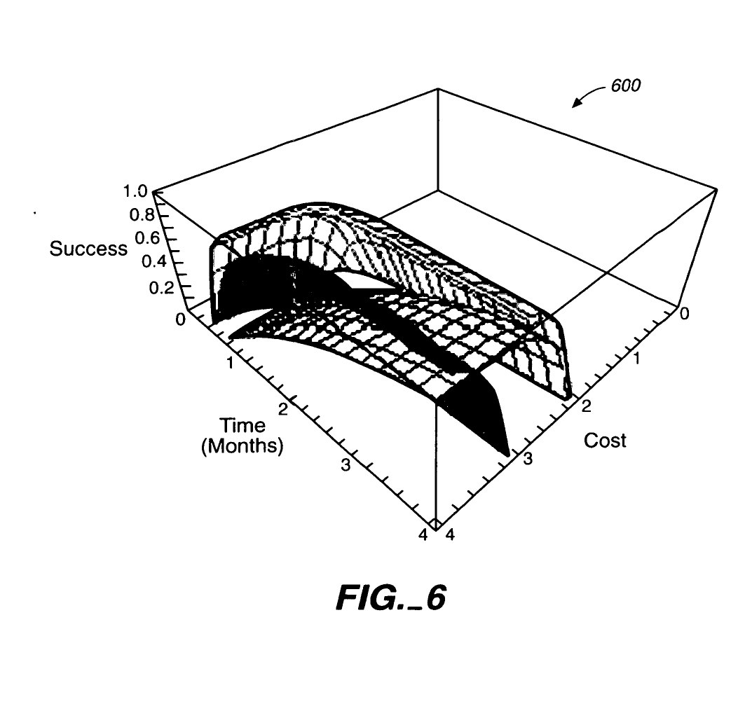

From the task window 202 shown in FIG. 2, when the success plots updated from sliders button 226 is pushed, the task window 200 shown in FIG. 2 changes to the task window shown in FIG. 5. As shown in FIG. 5, the presentation area 202 now includes a first success plot 502, a second success plot 504, and a color legend 506. The success plots 502 and 504 each are a 3-D plot having a time axis, a cost axis and a success axis. Success is one minus risk. In a preferred embodiment, the present invention displays the success plots 502 and 504 differently from the risk plots 232, 234, and 236 shown in FIGS. 2 through 4. Instead of plotting a different success surface for each technology, all three success surfaces are plotted on the same axes so a user may easily compare them. The success plot 502 and the success plot 504 have exactly the same data, except the plot 502 is a cutaway view of the plot 504 (the top of the plot 504 is cut away). The plot 502 may thus enable a user to see the underlying structure, and the plot 504 may enable a user to see which technology is the least risky. FIG. 6 shows an additional exemplary cutaway view of a success plot in accordance with the present invention

Referring generally now to FIGS. 7 through 9, exemplary task windows of a graphical user interface including exemplary global cost plots are shown in accordance with the present invention. From the task window 202 shown in FIG. 3, when the global cost plots updated from text button 230 is pushed, the task window 200 shown in FIG. 3 changes to the task window shown in FIG. 7. As shown in FIG. 7, the presentation area 202 includes a scatter plot 702, a bar chart (histogram) 704, and a color legend. The scatter plot 702 is a 3-D plot having an axis for the number of customizable gates, an axis for time to prototype, and an axis for the yearly volume. The scatter plot 702 is used to showing a function of three independent variables (the number of customizable gates, time to prototype, and yearly volume) as opposed to just two shown in the foregoing described risk plots and success plots. In a preferred embodiment, the axis scale range for the number of gates varies from the value shown in the subsection 250 to the value shown in the subsection 242, the axis scale range for the yearly volume varies from the value shown in the subsection 252 to the value shown in the subsection 248, and the axis scale range for time to prototype varies from 1 (one) to the value shown in the subsection 246. For a set of input variable values represented by a point or a dot inside the scatter plot 702, the program of the present invention may calculate the cost for FPGA, RapidChip™, and ASIC, respectively, and then choose the technology with the lowest cost. The program then displays the dot in a color representing the technology with the lowest cost. However, if the technology with the lowest cost is infeasible (i.e., has negative cost because there is not enough part shift to pay for the development), the corresponding dot may be marked in a color showing “infeasible.” In a preferred embodiment, the number of global points shown in the global parameters section 258 (may be set by a user) indicates the number of dots to be displayed in the scatter plot 702. The dots may be randomly chosen by the present program. Thus, a user may easily see the technology with the lowest cost for a certain set of input variable values from the scatter plot 702. For example, when a user sees a blue dot and when blue represents RapidChip™ based on the color legend 706, the user may understand that RapidChip™ has the lowest cost with the number of customizable gates, the time to prototype, and the yearly volume represented by the blue dot. Moreover, a user may also judge which technology has the lowest cost from the distribution of different color in the scatter plot 702.

The bar chart 704 shows a slack profit (effectively gross margin) for a chosen dot inside the scatter plot 702. For the chosen dot, the program calculates the cost for FPGA, RapidChip™, and ASIC, respectively, and selects the two technologies with the top two positive costs (i.e., two profitable technologies). Based on the price/cost slack in dollars indicated in the global parameters section 258 and the yearly product volume indicated in the subsection 248, the program then calculates the profit for each of the two chosen technologies. In a preferred embodiment, the price/cost slack indicated in the global parameters section 258 may be changed by a user. For example, a user may change the price/cost slack shown in FIG. 7 from $500 to $200 (not shown). Next, the less profitable technology is used as the baseline, and the profit difference between the two selected technologies is plotted in the bar chart 704. For example, in the bar chart 704 shown in FIG. 7, for the chosen dot, RapidChip™ is used as the baseline, and ASIC is the most profitable technology.

It is understood that the values on the axes of the scatter plot 702 shown in FIG. 7 may be adjusted directly by a user using the cursor to directly manipulate the values on the axes without using the sliders, and the bar chart 704 may change in real time in concert with the manipulation of any of the values on the axes. That is, a user may interact with the axes of the scatter plot 702 directly, and as the values move along the axes, the computed histogram 704 (which is dependent on the model value as a function of the input) may change dynamically in real time so that the user may actually see the transition areas from FPGA slack profit to RapidChip™ to ASIC. It is understood that a number of other presentations and input methods like the foregoing mentioned may be used in real time where the dynamic input is related to the real-time-varying output without departing from the scope and spirit of the present invention.

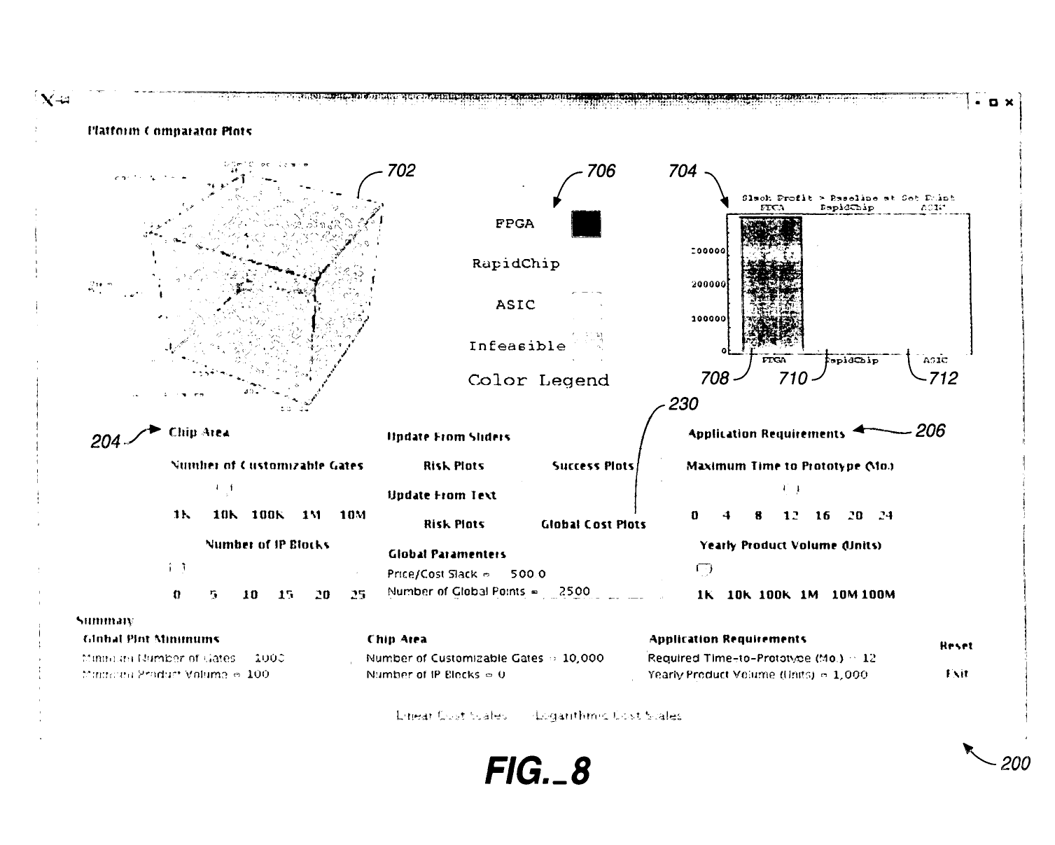

From the task window 202 shown in FIG. 4, when the global cost plots updated from text button 230 is pushed, the task window 200 shown in FIG. 4 changes to the task window shown in FIG. 8. As shown in FIG. 8, the scatter plot 702 changes accordingly, and the bar chart 704 includes a FPGA bar 708, a RapidChip bar 710 and an ASIC bar 712. Different from FIG. 7, the bar chart 704 shown in FIG. 8 does not show a baseline. It is easily understandable that for the chosen dot (thus the chosen input variable values) FPGA is most profitable and ASIC is the least profitable.

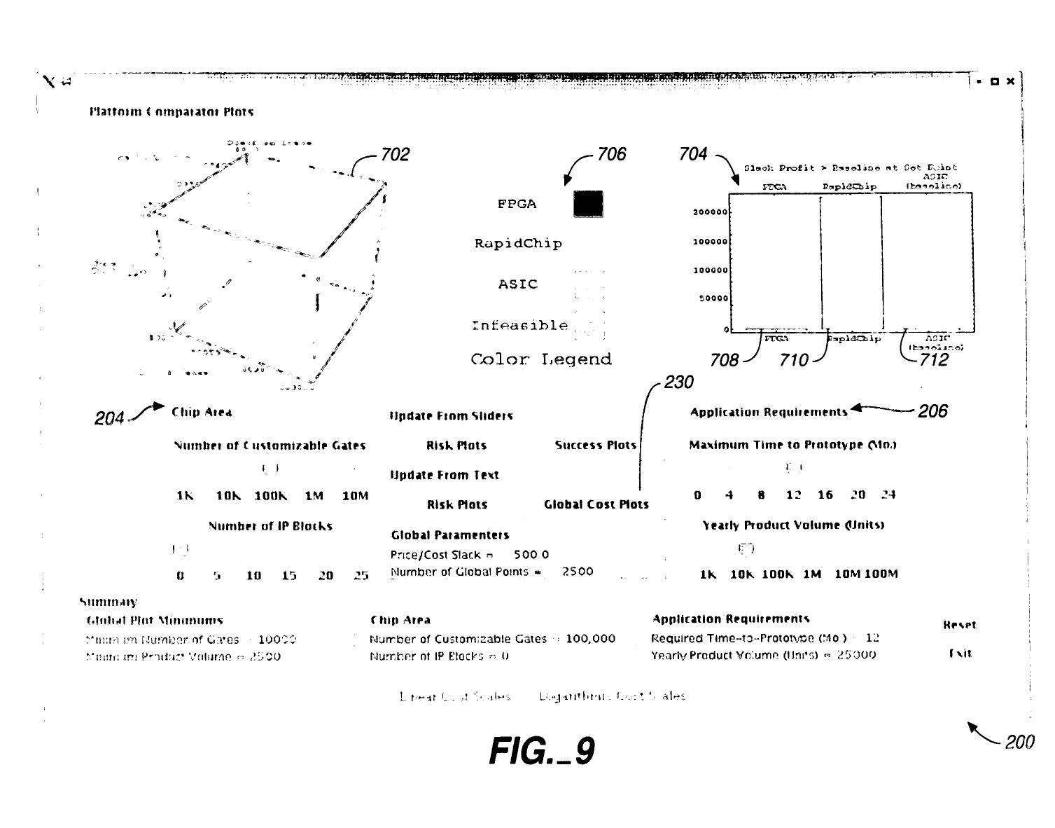

From the task window 202 shown in FIG. 8, when the number of customizable gates is increased from 10,000 to 100,000 and the yearly product volume is increased from 1,000 units to 25,000 units, the task window 200 shown in FIG. 8 changes to the task window shown in FIG. 9. As shown in FIG. 9, the scatter plot 702 changes accordingly, and for the chosen dot (thus the chosen input variable values) RapidChip™ is most profitable and ASIC is used as the baseline.

It is understood that the task window of a graphical user interface shown in FIGS. 2 through 9 is intended as exemplary only and not as an architectural limitation to the present invention. Those of ordinary skill in the art will appreciate that various combinations and arrangements may be employed without departing from the scope and spirit of the present invention.

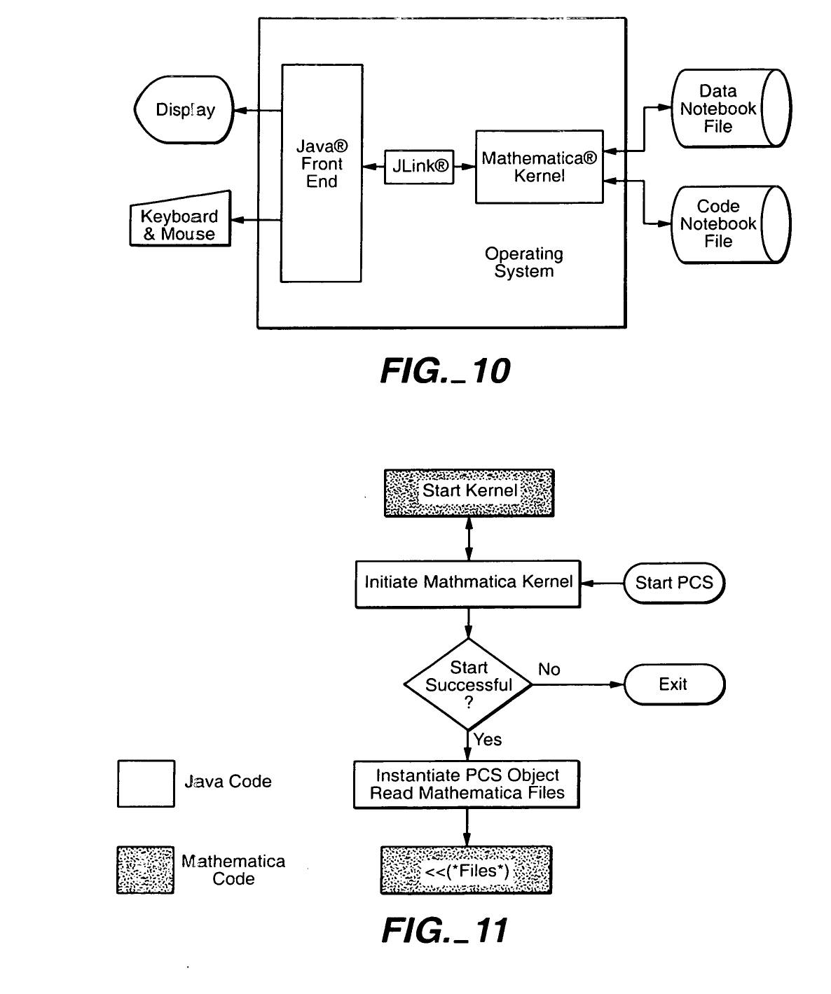

FIG. 10 shows a schematic block diagram of an exemplary system 1000 for the platform comparator in accordance with the present invention. The system 1000 includes an operating system 1002 such as Linux, Solaris®, Windows®, Unix, and the like, a display 1010, a keyboard and mouse 1012, a Data Notebook file 1014, and a Code Notebook file 1016. The operation system 1002 includes a Java® front end 1004 operatively coupled to the display 1010 and the keyboard and mouse 1012, and a Mathematica® kernel 1006 operatively coupled to the Data Notebook file 1014 and the Code Notebook file 1016. The Java® front end 1004 may be operatively coupled to the Mathematica® kernel 1006 through an interface JLink®, which allows Mathematica® to be run from Java®. Java® is used preferably for implementing the sliders and capturing the values that are set by the sliders, and Mathematica® is preferably used both for the computation of the mathematical models and the expression of the results in 3-D graphical form. Those of ordinary skill in the art will understand that Mathematica® is very effective when implementing the data structure, the code, the engine, the analysis engine, and the like. However, Mathematica® does not have a tremendously friendly user interface. Furthermore, Mathematica® is a very expensive program. Thus, in a preferred embodiment, the front end of the platform comparator may be built in Java® (which is very Web-friendly) running on the Web, and the expensive Mathematica® engine may run on a server. This way, many users may use the platform comparator but there is no need to provide a copy of Mathematica® for each user. Alternatively, the Java® front and Mathematica® may be both run on a single computer, such as a notebook, a main frame computer, a desktop computer, a workstation, and the like.

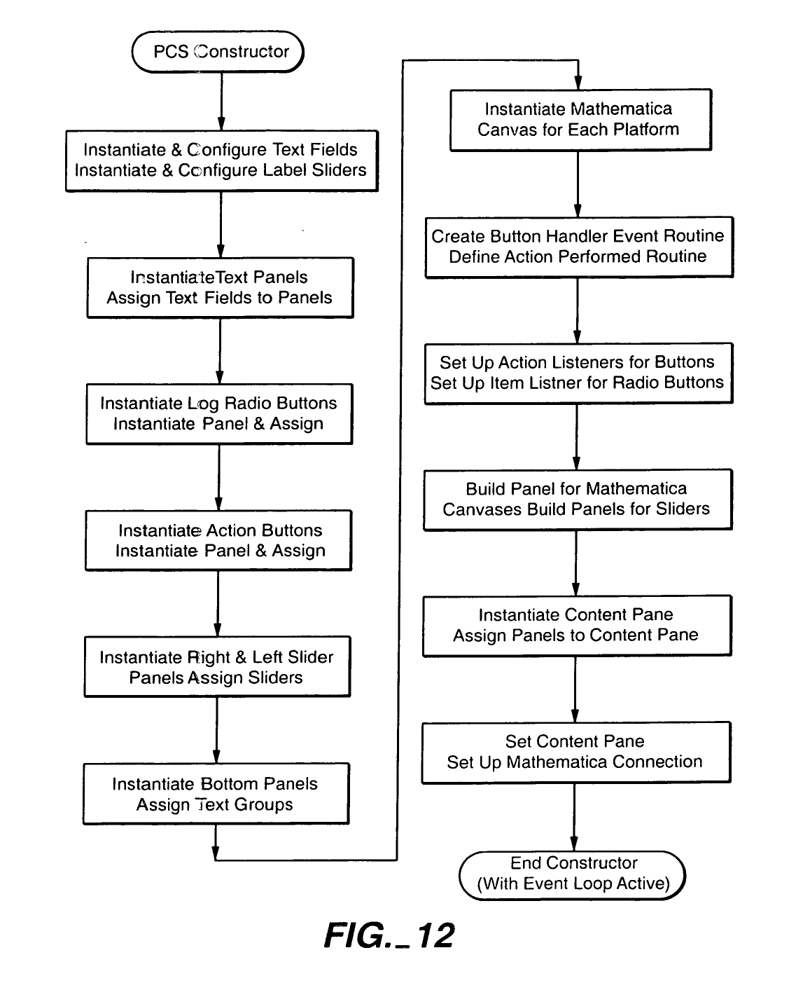

FIGS. 11 and 12 show exemplary processes of platform comparator (PCS) Java® initiation and constructor in accordance with the present invention. As shown in FIG. 11, Mathematica® may be run from Java® and may read all the data files after successful launching. As shown in FIG. 12, the Java® front end may set up the windows and the math canvass of those windows, initialize all of these various variables, set up program constants (e.g., the initial number of customizable gates, and the like), the user interface, the sliders, the label sliders, the buttons, the slider-button panel, the text-button panel, and the like. In other words, the Java® front end instantiates all necessary objects.

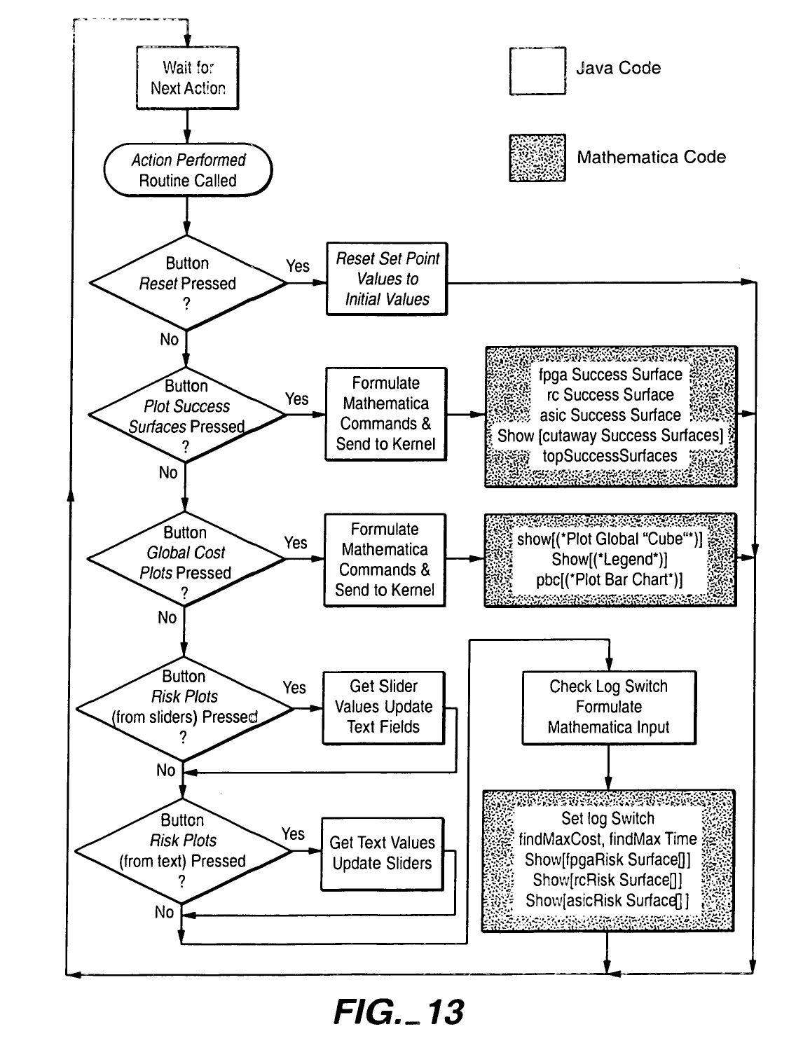

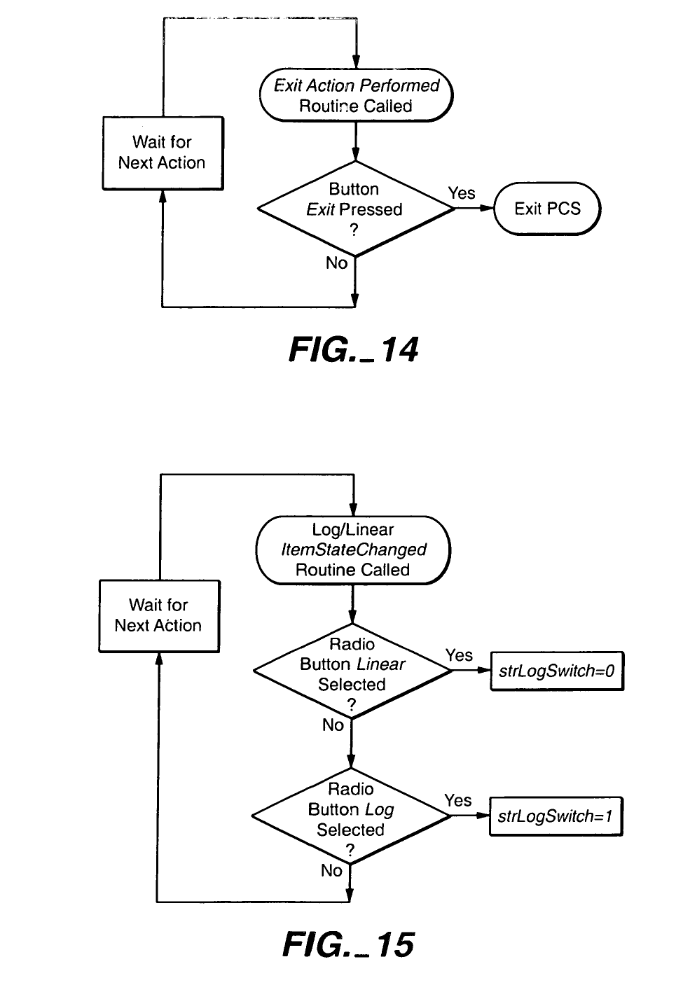

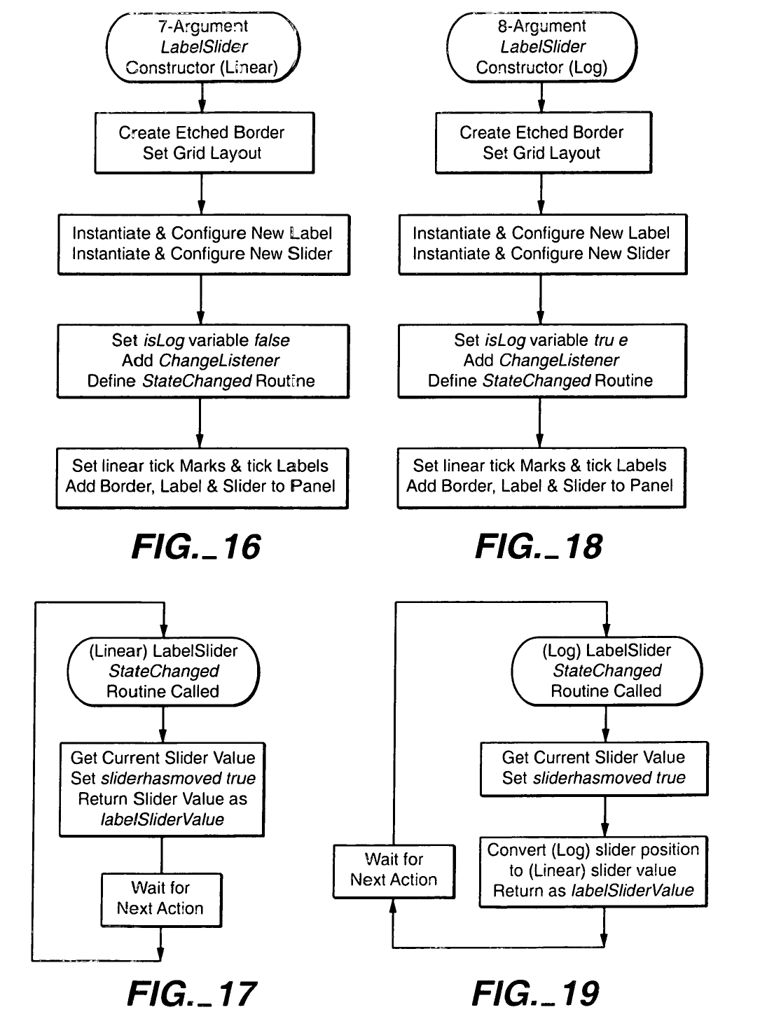

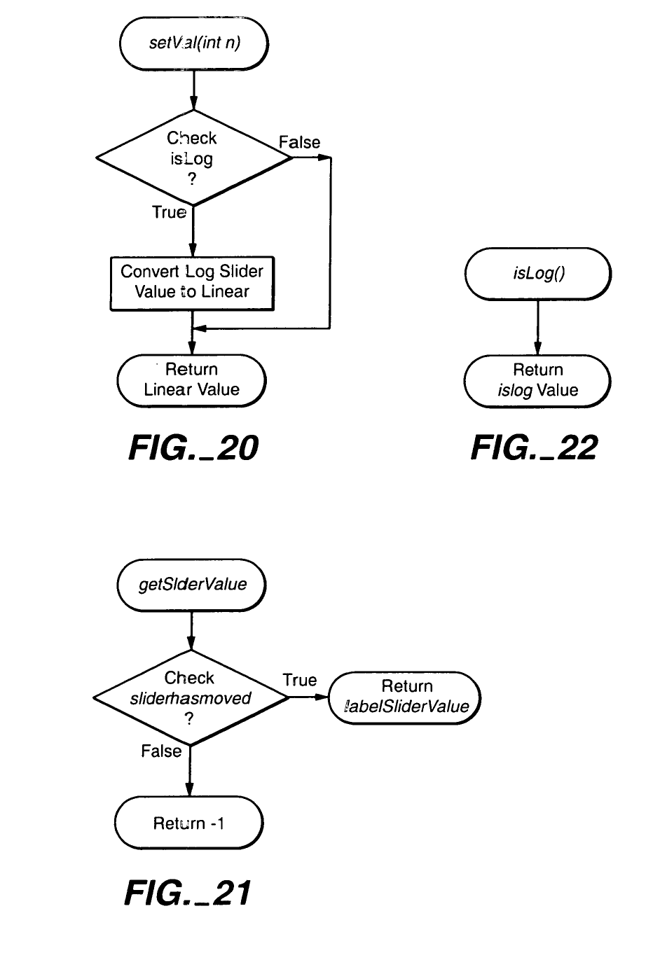

FIG. 13 shows an exemplary action performed event loop 1300 in accordance with the present invention. The action performed event loop 1300 may be defined at step 1218 shown in FIG. 12. FIGS. 14 and 15 show an exemplary exit event loop and an exemplary log/linear event loop in accordance with the present invention, respectively. FIGS. 16 and 17 show an exemplary linear labelslider constructor and event routine in accordance with the present invention, and FIGS. 18 and 19 show an exemplary logarithmic labelslider constructor and event routine in accordance with the present invention. FIGS. 20 through 22 show exemplary labelslider methods.

Although FIGS. 10 through 22 show that the platform comparator of the present invention is implemented in Mathematica® and Java@, those of ordinary skill in the art will understand that the platform comparator of the present invention may also be implemented in any other language, including C++, Digital BASIC, and the like without departing from the scope and spirit of the present invention.

It is to be noted that the foregoing described embodiments according to the present invention may be conveniently implemented using conventional general purpose digital computers programmed according to the teachings of the present specification, as will be apparent to those skilled in the computer art. Appropriate software coding may readily be prepared by skilled programmers based on the teachings of the present disclosure, as will be apparent to those skilled in the software art.

It is to be understood that the present invention may be conveniently implemented in forms of software package. Such a software package may be a computer program product which employs a storage medium including stored computer code which is used to program a computer to perform the disclosed function and process of the present invention. The storage medium may include, but is not limited to, any type of conventional floppy disks, optical disks, CD-ROMS, magneto-optical disks, ROMs, RAMs, EPROMs, EEPROMs, magnetic or optical cards, or any other suitable media for storing electronic instructions.

It is understood that the specific order or hierarchy of steps in the processes disclosed is an example of exemplary approaches. Based upon design preferences, it is understood that the specific order or hierarchy of steps in the processes may be rearranged while remaining within the scope of the present invention. The accompanying method claims present elements of the various steps in a sample order, and are not meant to be limited to the specific order or hierarchy presented.

It is believed that the present invention and many of its attendant advantages will be understood by the foregoing description. It is also believed that it will be apparent that various changes may be made in the form, construction and arrangement of the components thereof without departing from the scope and spirit of the invention or without sacrificing all of its material advantages. The form herein before described being merely an explanatory embodiment thereof, it is the intention of the following claims to encompass and include such changes.

1. A method for comparing integrated circuit technologies, comprising:
(a) receiving input variables for a plurality of integrated circuit technologies;
(b) processing said common input variables; and
(c) displaying at least one output variable for each of said plurality of integrated circuit technologies in a graphical form so that said plurality of integrated circuit technologies are comparable based on said at least one output variable.

2. The method of claim 1, wherein said plurality of integrated circuit technologies comprises RapidChip™.

3. The method of claim 2, wherein said plurality of integrated circuit technologies further comprises ASIC (application-specific integrated circuit) and FPGA (field-programmable gate array).

4. The method of claim 1, wherein said input variables comprise number of customizable gates, maximum time to prototype, and yearly product volume.

5. The method of claim 4, wherein said input variables further comprise number of IP (intellectual property) blocks.

6. The method of claim 1, wherein said input variables are set with sliders in a task window of a graphical user interface by a user.

7. The method of claim 1, wherein said at least one output variable comprises risk and cost.

8. The method of claim 7, wherein said graphical form is a 3-D plot having a first axis for time to prototype, a second axis for said cost, and a third axis for said risk.

9. The method of 8, wherein each of said plurality of integrated circuit technologies has a separate 3-D plot.

10. The method of claim 1, wherein said at least one output variable comprises success and cost.

11. The method of claim 10, wherein said graphical form is a 3-D plot having a first axis for time to prototype, a second axis for said cost, and a third axis for said success.

12. The method of 11, wherein said plurality of integrated circuit technologies have a single 3-D plot, and each of said plurality of integrated circuit technologies is represented by different color.

13. The method of claim 1, wherein said graphical form comprises a scatter plot having a first axis for time to prototype, a second axis for number of customizable gates, and a third axis for yearly volume, said scatter plot having a plurality of dots, each dot in color representing one of said plurality of integrated circuit technologies with the least cost or in color representing infeasibility.

14. The method of claim 13, wherein said graphical form further comprises a bar chart showing a slack profit for one of said plurality of integrated circuit technologies for a selected dot.

15. The method of claim 14, wherein when a user moves a value along one of said axes of said scatter plot, said bar chart changes dynamically in real time.

16. A computer-readable medium having computer-executable instructions for performing a method for comparing integrated circuit technologies, said method comprising steps of:
(a) receiving input variables for a plurality of integrated circuit technologies;
(b) processing said common input variables; and
(c) displaying at least one output variable for each of said plurality of integrated circuit technologies in a graphical form so that said plurality of integrated circuit technologies are comparable based on said at least one output variable.

17. The computer-readable medium of claim 16, wherein said plurality of integrated circuit technologies comprises RapidChip™.

18. The computer-readable medium of claim 17, wherein said plurality of integrated circuit technologies further comprises ASIC (application-specific integrated circuit) and FPGA (field-programmable gate array).

19. The computer-readable medium of claim 16, wherein said input variables comprise number of customizable gates, maximum time to prototype, and yearly product volume.

20. The computer-readable medium of claim 19, wherein said input variables further comprise number of IP (intellectual property) blocks.

21. The computer-readable medium of claim 16, wherein said input variables are set with sliders in a task window of a graphical user interface by a user.

22. The computer-readable medium of claim 16, wherein said at least one output variable comprises risk and cost.

23. The computer-readable medium of claim 22, wherein said graphical form is a 3-D plot having a first axis for time to prototype, a second axis for said cost, and a third axis for said risk.

24. The computer-readable medium of 23, wherein each of said plurality of integrated circuit technologies has a separate 3-D plot.

25. The computer-readable medium of claim 16, wherein said at least one output variable comprises success and cost.

26. The computer-readable medium of claim 25, wherein said graphical form is a 3-D plot having a first axis for time to prototype, a second axis for said cost, and a third axis for said success.

27. The computer-readable medium of 26, wherein said plurality of integrated circuit technologies have a single 3-D plot, and each of said plurality of integrated circuit technologies is represented by different color.

28. The computer-readable medium of claim 16, wherein said graphical form comprises a scatter plot having a first axis for time to prototype, a second axis for number of customizable gates, and a third axis for yearly volume, said scatter plot having a plurality of dots, each dot in color representing one of said plurality of integrated circuit technologies with the least cost or in color representing infeasibility.

29. The computer-readable medium of claim 28, wherein said graphical form further comprises a bar chart showing a slack profit for one of said plurality of integrated circuit technologies for a selected dot.

30. The computer-readable medium of claim 29, wherein when a user moves a value along one of said axes of said scatter plot, said bar chart changes dynamically in real time.

31. A computer system comprising:
a central processing unit;
a display operatively coupled to said central processing unit; and
memory operatively coupled to said central processing unit, said memory including an operating system having a graphical user interface;
wherein via said graphical user interface, said computer system receives input variables for a plurality of integrated circuit technologies, and, after processing said common input variables, displaying at least one output variable for each of said plurality of integrated circuit technologies in a graphical form so that said plurality of integrated circuit technologies are comparable based on said at least one output variable.

32. The computer system of claim 31, wherein said plurality of integrated circuit technologies comprises RapidChip™.

33. The computer system of claim 32, wherein said plurality of integrated circuit technologies further comprises ASIC (application-specific integrated circuit) and FPGA (field-programmable gate array).

34. The computer system of claim 31, wherein said input variables comprise number of customizable gates, maximum time to prototype, and yearly product volume.

35. The computer system of claim 34, wherein said input variables further comprise number of IP (intellectual property) blocks.

36. The computer system of claim 31, wherein said input variables are set with sliders in a task window of said graphical user interface by a user.

37. The computer system of claim 31, wherein said at least one output variable comprises risk and cost.

38. The computer system of claim 37, wherein said graphical form is a 3-D plot having a first axis for time to prototype, a second axis for said cost, and a third axis for said risk.

39. The computer system of 38, wherein each of said plurality of integrated circuit technologies has a separate 3-D plot.

40. The computer system of claim 31, wherein said at least one output variable comprises success and cost.

41. The computer system of claim 40, wherein said graphical form is a 3-D plot having a first axis for time to prototype, a second axis for said cost, and a third axis for said success.

42. The computer system of 41, wherein said plurality of integrated circuit technologies have a single 3-D plot, and each of said plurality of integrated circuit technologies is represented by different color.

43. The computer system of claim 31, wherein said graphical form comprises a scatter plot having a first axis for time to prototype, a second axis for number of customizable gates, and a third axis for yearly volume, said scatter plot having a plurality of dots, each dot in color representing one of said plurality of integrated circuit technologies with the least cost or in color representing infeasibility.

44. The computer system of claim 43, wherein said graphical form further comprises a bar chart showing a slack profit for one of said plurality of integrated circuit technologies for a selected dot.

45. The computer system of claim 44, wherein when a user moves a value along one of said axes of said scatter plot, said bar chart changes dynamically in real time.

46. The computer system of claim 31, wherein said central processing unit is located in a server, and said memory is located in a client.
